(19) United States
(12) Patent Application Publication
(10) Pub. No.: US 2020/0036232 A1
(43) Pub. Date: Jan. 30, 2020

(54) OPERATIONAL CONTROL OF WIRELESS CHARGING

(71) Applicant: Walmart Apollo, LLC, Bentonville, AR (US)

(72) Inventors: Nathan JONES, Bentonville, AR (US); Michael Dean ATCHLEY, Eureka Springs, AR (US); David C. WINKLE, Bella Vista, AR (US)

(21) Appl. No.: 16/517,665

(22) Filed: Jul. 22, 2019

Related U.S. Application Data
(60) Provisional application No. 62/711,268, filed on Jul. 27, 2018.

(51) Int. Cl. H02J 50/23; B60L 53/126

(52) U.S. Cl. CPC H02J 50/23; B64C 2201/066; B64C 2201/042; B60L 53/126

(57) ABSTRACT

Coordinated operational control of wireless charging includes receiving a notification from a first and second drone requesting charging and responsive to determining that a sufficient amount of charging resources is not available to permit charging both drones simultaneously, prioritizing charging of drones so that at least one drone is instructed to wait. The drones may be a combination of autonomous vehicles, UAVs, and UGVs. A charging corral may be used, and navigation instructions to the charging corral may be provided to a drone. Re-orientable antennas may be used to direct RF charging power in a selected direction, for example, to track the location of a drone.

### CROSS-REFERENCE TO RELATED APPLICATION

This application claims the benefit of U.S. Provisional Application No. 62/711,268, filed Jul. 27, 2018, entitled “Operational Control of Wireless Charging”, the entirety of which is hereby incorporated by reference herein.

### BACKGROUND

Autonomous vehicles, including unmanned aerial vehicles (UAVs) and unmanned ground vehicles (UGVs), commonly known as drones, often run on batteries and thus require recharging. Autonomous or semi-autonomous drones may provide labor savings in some situations by handling certain transport duties. As a fleet of drones grows, battery maintenance and charging may become cumbersome. Thus, as autonomy and reliance upon drones increases, single-point charging solutions risk becoming insufficient for large fleets or other collections of autonomous drones.

### SUMMARY

Coordinated operational control of wireless charging includes receiving a notification from a first and second drone requesting charging and responsive to determining that a sufficient amount of charging resources is not available to permit charging both drones simultaneously, prioritizing charging of drones so that at least one drone is instructed to wait. The drones may be a combination of autonomous vehicles, including unmanned aerial vehicles (UAVs) and unmanned ground vehicles (UGVs). A charging corral may be used, and navigation instructions to the charging corral may be provided to a drone. Re-orientable antennas may be used to direct RF charging power in a selected direction, for example, to track the location of a drone.

Some embodiments of a system for operational control of wireless charging, implemented on at least one processor, comprises: a processor; and a computer-readable medium storing instructions that are operative when executed by the processor to: receive a notification from a first drone indicating that the first drone is requesting charging; receive a notification from a second drone indicating that the second drone is requesting charging; determine whether a sufficient amount of charging resources is available to permit charging both drones simultaneously; responsive to determining that a sufficient amount of charging resources is not available to permit charging both drones simultaneously: prioritize charging of the first drone and the second drone to select, from among the first drone and the second drone, an initially-charging drone and a later-charging drone; wirelessly charge the initially-charging drone; instruct the later-charging drone to wait for charging; and based at least on a sufficient amount of charging resources becoming available to permit charging the later-charging drone, wirelessly charge the later-charging drone.

### BRIEF DESCRIPTION OF THE DRAWINGS

The disclosed examples are described in detail below with reference to the accompanying drawing figures listed below:

FIG. 1 illustrates a wireless charging arrangement that provides for operational control of wireless charging;

FIG. 2 illustrates another wireless charging arrangement that provides for operational control of wireless charging;

FIG. 3 illustrates components of a drone that may be used with the wireless charging arrangements of FIGS. 1 and 2;

FIG. 4 illustrates an orchestration scenario for a set of multiple drones that exceeds the available charging capacity;

FIGS. 5-7 show flow charts illustrating exemplary operations involved in control of wireless charging; and

FIG. 8 is a block diagram of an example computing device for implementing aspects disclosed herein.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . .” For brevity and clarity of presentation, this implied leading clause is not repeated ad nauseum.

Autonomous vehicles, including unmanned aerial vehicles (UAVs) and unmanned ground vehicles (UGVs), commonly known as drones, are often operated in fleets. Since charging cycles only occupy sporadic time intervals, an owner of a drone fleet may have fewer charging stations than drones. As autonomous or semi-autonomous drones take on tasks at greater ranges, it is possible that some of the drones may require charging when away from their home zone. Drones may be tasked to retrieve goods from or deliver goods to some destination that is at such a distance from the home zone that the drone will require recharging at that destination. However, the owner of the drone may not be present at that destination (because the drone is sufficiently autonomous to complete the task itself), and so the owner does not have ownership or control over any charging solution at that destination.

One exemplary scenario is that a consumer sends an autonomous drone to a retail facility to collect some products that had been ordered. The drone is a UAV and is expected to fly to the retail location, wait for the products to be placed in a cargo hold, and then return to the consumer's residence with the products. However, upon arrival at the retail location, the drone determines that it lacks sufficient battery charge for the return trip.

Therefore, a need exists for a charging arrangement that provides for operational control of wireless charging, to both orchestrate charging scheduling when the number of drones requiring charging exceeds the charging capacity, and also to collect payment for the charging service from the owners of the drones. This may be conceptually similar to the arrangement of gasoline stations for automobiles; drivers expect to be able to obtain fuel when on long trips away from their houses—and to wait in line, if necessary at crowded stations, and to pay for the fuel. With autonomous drones, however, the waiting may be controlled by an orchestrator that instructs drones to either enter a charging station or area, or else wait until one becomes available.

The availability of wireless charging presents some options, including charging a drone that is not parked at a dedicated charging station. For example, UAVs in flight may be wirelessly recharged using transmitted radio frequency (RF) charging power—energy that is converted into direct current (DC) power for storage in on-board batteries. Because the RF power received by a drone is proportional to the inverse of the radial distance squared (P˜1/r²), charging power may require adjustment based on the distance between a drone and the RF transmitting antenna. The wireless charging solutions may be useful for UAVs, UGVs, spare batteries on-board drones, and other internet-of-things (TOT) devices, whether stationary or moving.

Referring to the figures, examples of the disclosure enable operational control of wireless charging. Operations may include receiving a notification from a first and second drone requesting charging and responsive to determining that a sufficient amount of charging resources is not available to permit charging both drones simultaneously, prioritizing charging of drones so that at least one drone is instructed to wait. The drones may be a combination of autonomous vehicles, including UAVs and UGVs. For example, the drones may include A charging corral may be used, and navigation instructions to the charging corral may be provided to a drone. Because the drones may be any of small UAVS and UGS; autonomous vehicles that are large enough to carry people, pallets of product, and possibly tow a large trailer; and autonomous aircraft that are large enough to carry people, pallets, or train-car sized cargo loads, the size of the charging area may be on the order of square feet, square yards, or acres. Re-orientable antennas may be used to direct RF charging power in a selected direction, for example, to track the location of a drone.

For drones and other mobile equipment, charging may occur in some scenarios without docking, so that equipment can remain in service. This can increase the utilization rates for drones, decreasing downtime. These options may also enable different owners to each send their autonomous drones on longer-range tasks, with the expectation that charging power will be available at some point along the journey to recharge and thus complete the task.

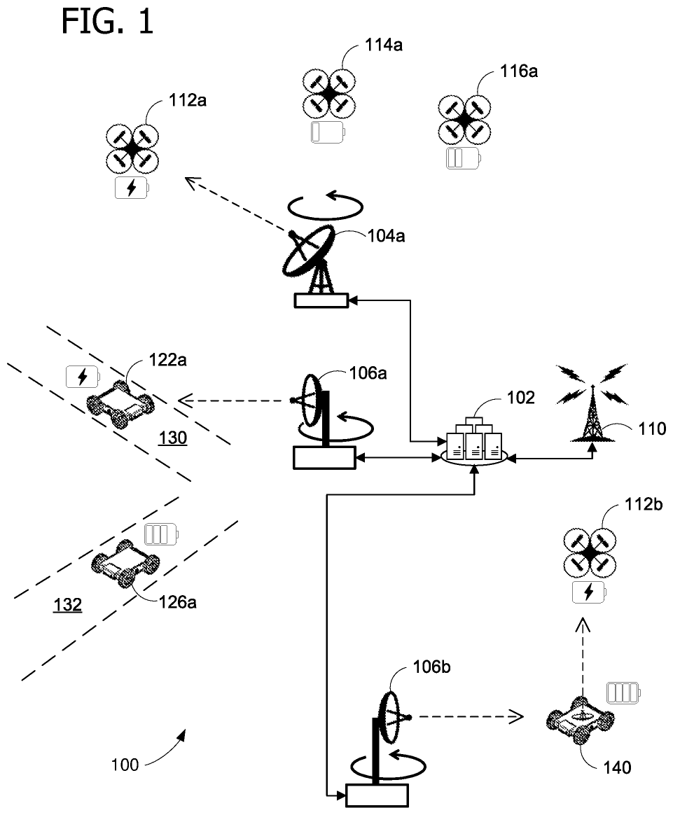

FIG. 1 illustrates a wireless charging arrangement 100, in which an orchestrator 102 provides operational control for distribution of wireless charging power. Coupled to orchestrator 102 are a first RF transmission station 104a, a second RF transmission station 106a, and a third RF transmission station 106b, although it should be understood that a different number may be used. RF transmission stations 104a, 106a, and 106b, each comprises a high-gain, re-orientable antenna for directing RF charging power in a selected direction. Also coupled to orchestrator 102 is a transceiver 110 that may act as a beacon and permit communication between orchestrator 102 and any drones requiring charging.

As illustrated, RF transmission station 104a is wirelessly charging an autonomous UAV drone 112a (showing a charging battery icon), while another autonomous UAV drone 114a requires charging (showing a low battery icon) and is waiting its turn to receive power from RF transmission station 104a. A third autonomous UAV drone 114a is in the vicinity of RF transmission station 104a, but still has enough remaining charge that it will likely not be charged prior to drone 114a. In the scenario thus illustrated, each of drones 112a, 114a, and 116a has communicated with orchestrator 102 to inform orchestrator 102 of the battery level and/or expected remaining battery life, and possibly also whether a task is currently scheduled (such as a return trip to a home zone) that cannot be accomplished with the expected remaining battery life.

In one mode of operation, orchestrator 102 had determined that, in the illustrated scenario, drone 112a was to be charged first, out of the set 112a, 114a, and 116a. As indicated, RF transmission station 104a is re-orientable, and thus may be tracking the location of drone 112a, if drone 112a is not stationary but is instead traveling toward some destination. When orchestrator 102 determines that RF transmission station 104a is finished charging drone 112a, orchestrator 102 may then re-orient RF transmission station 104a to aim at drone 114a. Alternatively, RF transmission station 104a may just be aimed at some traffic lane for autonomous UAV drones, so that any drone passing through the RF beam of RF transmission station 104a receives power. In this scenario, drone 112a may be in that area by its own navigational control, specifically to pick up charging energy, or may instead just be passing through.

Turning to the autonomous UGV drones, RF transmission station 106a is wirelessly charging an autonomous UGV drone 122a (showing a charging battery icon), while another autonomous UGV drone 126a is also in the vicinity of RF transmission station 106a. Drone 116a still has enough remaining charge that charging may not be critical. Similarly, with the autonomous UAV drones, each of drones 122a and 126a has communicated with orchestrator 102 to inform orchestrator 102 of the battery level and/or expected remaining battery life, and possibly also whether a task is currently scheduled (such as a return trip to a home zone) that cannot be accomplished with the expected remaining battery life. It should be understood that a drone may be sufficiently large enough to pull a full-sized cargo trailer or carry human passengers.

In one mode of operation, orchestrator 102 had determined that, in the illustrated scenario, drone 122a was to be charged first, out of the set 122a, and 126a. RF transmission station 106a is also re-orientable, and thus may be tracking the location of drone 122a, if drone 122a is not stationary but is instead traveling toward some destination in traffic lane 130. When orchestrator 102 determines that RF transmission station 106a is finished charging drone 122a, orchestrator 102 may then re-orient RF transmission station 106a to aim at another drone, such as drone 126a in traffic lane 132. Alternatively, RF transmission station 106a may just be aimed at traffic lane 130 for autonomous UGV drones, so that any drone passing through the RF beam of RF transmission station 106a in traffic lane 130 receives power. In this scenario, drone 122a may be in that area by its own navigational control, specifically to pick up charging energy, or may instead just be passing through.

Another mode of operation is illustrated with RF transmission station 106b, a power relay UGV drone 140 (which may not be autonomous, but instead under the control of orchestrator 102), and an autonomous UAV drone 112b. RF transmission station 106b (which is indicated as being re-orientable) is transmitting power to drone 140, which is relaying the power to drone 112b. Thus, drone 112b is being charged (showing a charging battery icon) via relayed power. In this illustrated scenario, orchestrator 102 may have determined that RF transmission station 106b could not track drone 112b sufficiently well to charge drone 112b. This may be due to some obstacle, such as a wall, a ceiling, or some other condition. Although each of the drones being charged, drones 112a, 122a, and 112b, is shown as being charged by a single RF transmission station 104a, 106a, and 106b, respectively, it should be understood that, in some situations, more than one RF transmission station may be transmitting power wirelessly to a drone in order to increase the rate of charging.

Drones 112a, 114a, 116a, 122a, 126a, and 112b each have an RF receiver module to receive the transmitted RF signals and convert them into DC power for charging batteries. This provides the ability to charge en route, minimizing delay and downtime. The RF power transmissions could be pointed along common traffic lanes (for both ground and air routes) or waiting areas. Drones may communicate with an orchestrator to request charging and arrange for payment for the charging service. For example, a drone may sense that it requires charging, locate a beacon (such as transceiver 110) and send its charging need, coordinates, and planned route, perhaps determined via differential GPS, and receive either a direction to a charging location, or RF transmission station will start sending power in the direction of the drone.

Charging may be complete either by a drone informing orchestrator 102 that its battery is full, or orchestrator 102 may determine that a second drone has a higher priority need, and thus ceases charging a first drone prior to the first drone being fully charged. For example, perhaps the first drone may have a sufficient battery level to complete its upcoming identified tasks; however, the second drone may be at risk of running out of battery power before it can reach another location with an available charging solution. Therefore, orchestrator 102 may need to prioritize limited charging resources among a larger number of drones signaling a need for charging. In some configurations, dedicated traffic lanes may be defined, and communicated to drones within the area by orchestrator 102 using transceiver 110. One example may be that different directions of travel for UAV drones may be at specified altitudes above ground, within narrow flight corridors.

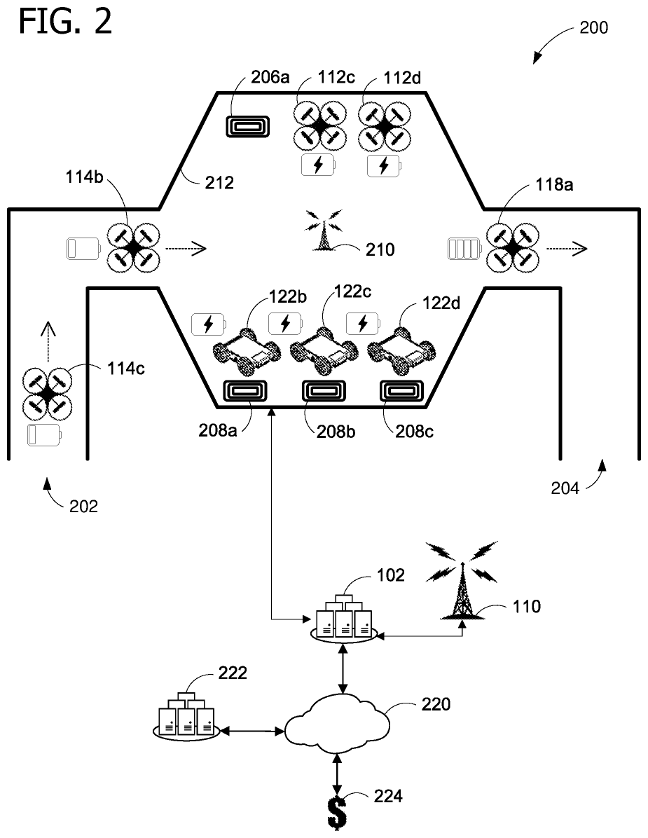

FIG. 2 illustrates a wireless charging corral 200, in which orchestrator 102 provides operational control for distribution of wireless charging power. An autonomous UAV drone 114b, in need of charging, is entering corral 200. Another autonomous UAV drone 114c, also in need of charging, is entering corral 200 behind drone 114b, through entrance 202. A fully-charged autonomous UAV drone 118a is exiting corral 200 through exit 204. Drone 114b has been instructed to use charging station 206a by orchestrator 102, possibly using transceiver 110. Charging 206a may be a landing pad with a coil similar to a near-field communication (NFC) coil, or some other arrangement. Autonomous UAV drones 112c and 112d are shown within corral 200 in the process of charging, perhaps having landed on other charging stations (which are obscured from view). Alternatively, autonomous UAV drones within corral 200 may not land on charging stations, but instead may hover and receive power from an RF transmission station, similar to RF transmission station 104a (of FIG. 1). Presumably, at least one of drones 112c and 112d is nearing completion of the charging time allocated by orchestrator 102, to make room for incoming drone 114c.

Also illustrated within corral 200 are autonomous UGV drones 122b, 122c, and 122d, each receiving power from one of charging stations 208a, 208b, and 208c. Charging stations 208a-208c may be similar to charging station 206a, so that a given charging station may charge either a UAV or a UGV, or the charging stations may be specifically tailored to either a UAV or a UGV (such as UAV landing pads and UGV parking stalls). Similarly, as for drones 112c and 112d, drones 122b-122d may instead be charged by receiving power from an RF transmission station, similar to RF transmission station 104a (of FIG. 1).

Within corral 200, a transceiver 210 may assist the drones with navigation and may relay commands and data to/from orchestrator 102. Transceiver 210 may optionally include an infrared beacon to assist incoming drones with navigation inside corral 200. In some embodiments, walls 212 of corral 200 may be designed to be impermeable to some wavelengths of RF, in order to confine charging power within corral 200. While this has the benefit of reducing stray RF signals causing interference with other devices outside corral 200, it may also prevent drones within corral 200 from communicating with orchestrator 102 through transceiver 110. In some scenarios, orchestrator 102 may control navigation and other behavior of drones nearby and within corral 200 using one of transceivers 110 and 210. While drones are within corral 200, being charged, this time may be used for receiving goods that had been scheduled for pick-up, or offloading deliveries.

Orchestrator 102 is further connected to a network 220 to enable communication with a remote node 222. Remote node 222 may be remote data storage, or provide computational services, such as assisting orchestrator 102 with calculating navigational routes or charging prioritization among multiple drones. Further orchestrator 102 is able to communicate with a billing service 224 that arranges for payment by the owners of drones that use charging corral 200. It should be understood that billing service 224 may also be used with arrangement 100 (of FIG. 1).

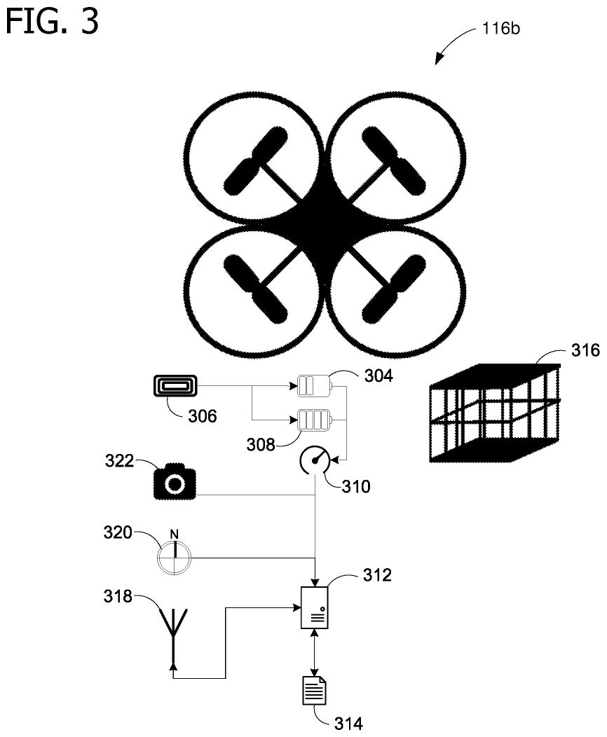

FIG. 3 illustrates components of an autonomous UAV drone 116b that may be used with wireless charging arrangement 100 and/or wireless charging corral 200 (of FIGS. 1 and 2, respectively). Drone 116b is illustrated as carrying a battery 304 that can be charged via a wireless power receiver 306. Wireless power receiver 306 converts received alternating current (AC) energy, received from RF transmissions and/or a near field coil, into DC energy. Drone 116b has a second battery 308, that may be electronically swapped out, if battery 304 is depleted. Wireless power receiver 306 may also charge battery 308, although if battery 308 is fully charged, drone 116b may have a lower priority for charging than another drone that does not have a second battery or has only a depleted second battery.

Battery charge levels are monitored by sensor 310 and reported to an on-board controller 312. On-board controller 312 has a date set 314 stored in memory, which may contain any of a cargo manifest of items within a cargo hold 316, a task list, a flight plan, navigational information, information to enable payment for charging services, the state of batteries 304 and 308, battery drain rates, expected remaining battery life, an alarm state that a task cannot be completed with the remaining battery life, and information necessary to ascertain compatibility with certain charging methods and equipment.

A transceiver 318, in communication with on-board controller 312 may be used for detecting beacon signals and communicating with orchestrator 102 (of FIGS. 1 and 2), as well as receiving navigation-related signals, such as perhaps GPS signals and/or piloting commands form orchestrator 102. Navigation information received through transceiver 318 may be forwarded to a navigation module 320 to control the flight operations of drone 116b. Additionally, an optional camera 322 may be used to record the drone's behavior or permit other controllers or human operators to monitor the status of drone 116b.

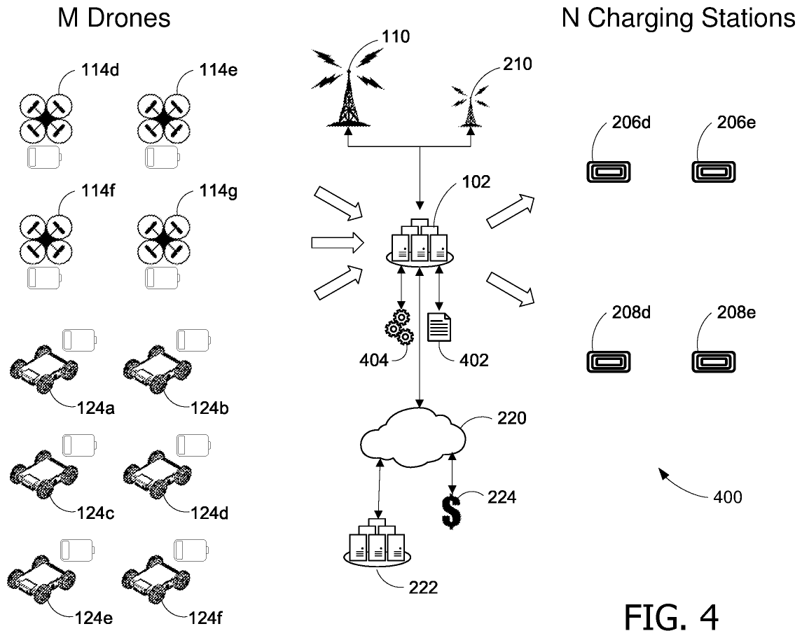

FIG. 4 illustrates an orchestration scenario 400 for a set of multiple drones that exceeds the available charging capacity. As illustrated, a total of ten drones, autonomous UAV drones 114d-114g and autonomous UGV drones 124a-124f are all in need of charging (as seen by the low battery icons). Unfortunately, there exists sufficient capacity to charge only four drones at a time, using charging stations 206d-206e and 208d-208e. In some situations, both UAV and UGV drones may use an of the charging stations (206d-206e and 208d-208e), whereas in other situations, charging stations 206d-206e may service only UAV drones and charging stations 208d-208ea may service only UGV drones. Whichever situation exists, prioritization is needed. Orchestrator 102 provides the prioritization that permits orderly operational control and coordination for charging multiple autonomous drone units.

Orchestrator 102 includes a data store 402 and prioritization logic 404, in order to provide orderly operational control of wireless charging activities and operations. Specifically, orchestrator 102 may define the order of the drones 114d-114g and 124a-124f that access charging resources (stations) 206d-206e and 208d-208e, as well as allocating charging time, providing navigation instructions or control, and arranging for payment for the charging service such as by subscribers to a wireless charging plan. Each of drones 114d-114g and 124a-124f has a capability to charge based off ambient signals, and to communicate, via RF signal transmission, detailing its location and battery level.

Data store 402 contains data received from drones, for example, for a particular drone, there may be a database entry including the drone type, identification (ID), make, model, owner, position, number of batteries, battery charge level, and information necessary to ascertain the urgency of receiving a charge. This may include the battery drain rate and the remaining tasks prior to another charging opportunity. For example, if a first drone's current battery charge and battery drain rate indicate depletion within 30 minutes, but the first drone has instructions to return to the owner's home location via a 40-minute commute, and if a second drone's current battery charge and battery drain rate indicate depletion within 20 minutes, but the first drone has instructions to return to the owner's home location via a 10-minute commute, then orchestrator 102 may determine that the first drone will have charging priority over the second drone. Some examples, however, may use simpler determinations.

Data store 402 may also contain an indication of a drone's cargo capacity, either total and/or available (in the case of a partial load already being on-board), and indications of the dimensions and weight of items to pick up. This may permit orchestrator 102 to determine whether the drone's battery drain rate will increase, and also determine whether the drone should be sent away without attempting to pick up items, because the available cargo capacity is insufficient.

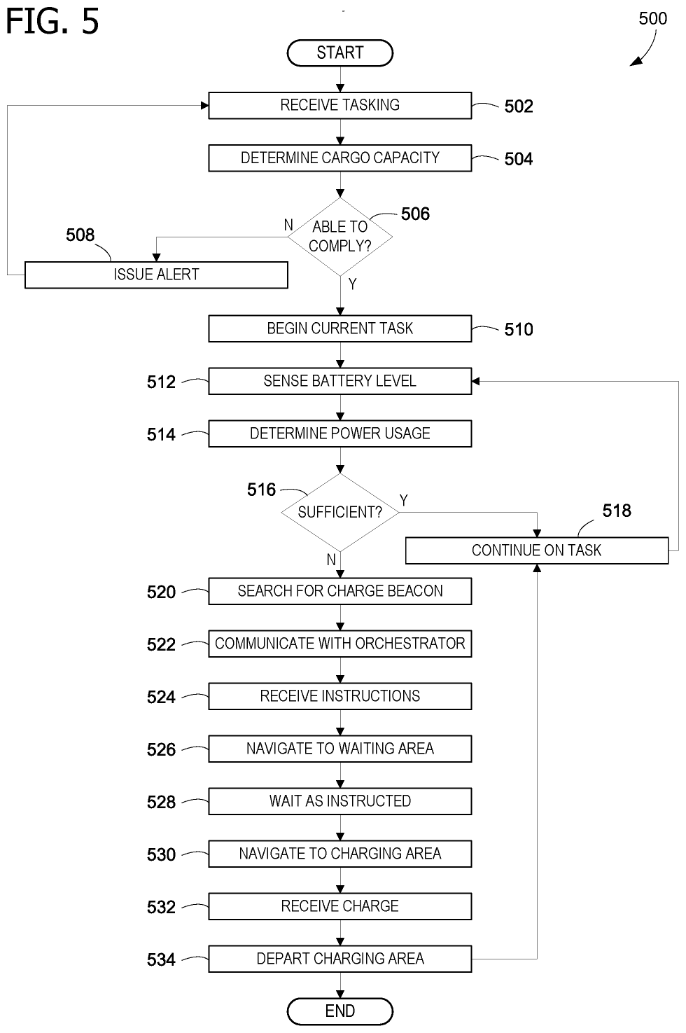

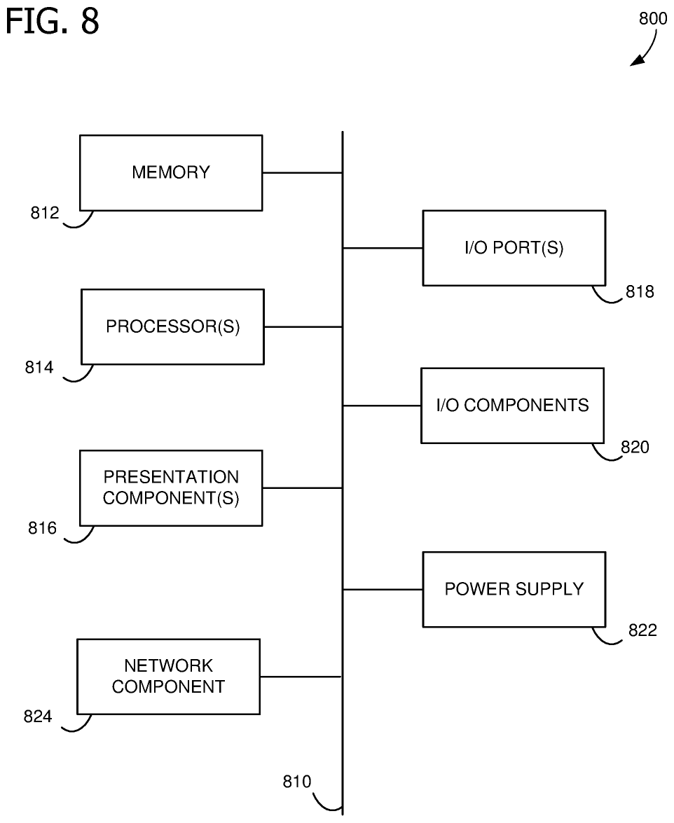

FIG. 5 shows a flow chart 500 illustrating exemplary operations involved in control of wireless charging, such as a drone performing tasks and requesting charging power when required. The operations illustrated in flow chart 500 may be performed using a compatible processing unit or computing node, such as the computing device of FIG. 8. Operation 502 includes receiving tasking, perhaps a single task to go to a remote location and retrieve or deliver some items, or a list of multiple tasks. The tasking may include a description of the items to retrieve, including cumulative packed dimensions and weight. The available cargo capacity, including dimensions and weight is determined 504, and decision operation 506, determines whether the drone can comply with the task. If the drone cannot comply, an alert is issued 508, and remedial instructions are awaited, when returning to operation 502. Otherwise, the drone begins its current task in operation 510.

The drone will continually sense its battery level in operation 512 and determine its power usage in operation 514. This may include comparing the levels at various times to determine battery drain rate, as well as estimating differing future battery drain rates based on differing expected cargo loads at various times. In decision operation 516, the drone determines whether it has sufficient battery power to accomplish its tasking, or whether will require charging. If the drone has sufficient remaining battery power, it continues on its task 518, and continues sensing its battery level 512. Otherwise, the drone searches for a charging beacon, for example transceiver 110 connected to orchestrator 102 of (FIGS. 1, 2 and 4), in operation 520.

Upon locating a charging solution, the drone communicates with the orchestrator associated with the charging beacon in operation 522, for example, communicating with orchestrator 102 via transceiver 110. During this communication, the drone informs the orchestrator of its battery level and task, which may include a flight plan. The drone receives instructions 524 from the orchestrator. The orchestrator may direct the drone to a charging corral for in-place charging (hovering or landed) or may instead direct the drone to follow its current flight path or detour through a particular traffic lane. If the charging option involves the use of directed antennas, such as RF transmission station 104a (of FIG. 1), the instructions may include instructions to hover at a particular location or fly slowly during a time period of exposure to charging energy or waiting for charging to commence. In operation 526, the drone navigates to a waiting area, if instructed to do so, and waits 528, until its turn for charging. The waiting area may be its current route, just hovering or flying slowly, while charging resources become available.

The drone navigates to the charging area in operation 530, possibly following instructions from the orchestrator, or possibly having its flight controlled by the orchestrator. The charging area may be a corral, a particular traffic lane, or even the drone's original route. Charging power is received in operation 532, until either the drone has signaled that the battery is sufficiently charged (e.g., the battery is full, or the owner has only pre-authorized a certain charging expense), or the orchestrator determines that charging resources are needed for a higher priority task. The drone then departs the charging area 534 and continues on its task 518. Although flow chart 500 has been described for a UAV drone, it should be understood that the same logic flow may be used for a UGV drone, with hovering and landing possibly omitted from the received instructions. Additionally, it should be understood that flow chart 500 may be accomplished by a fully-autonomous drone, a semi-autonomous drone, or a manually-controlled drone.

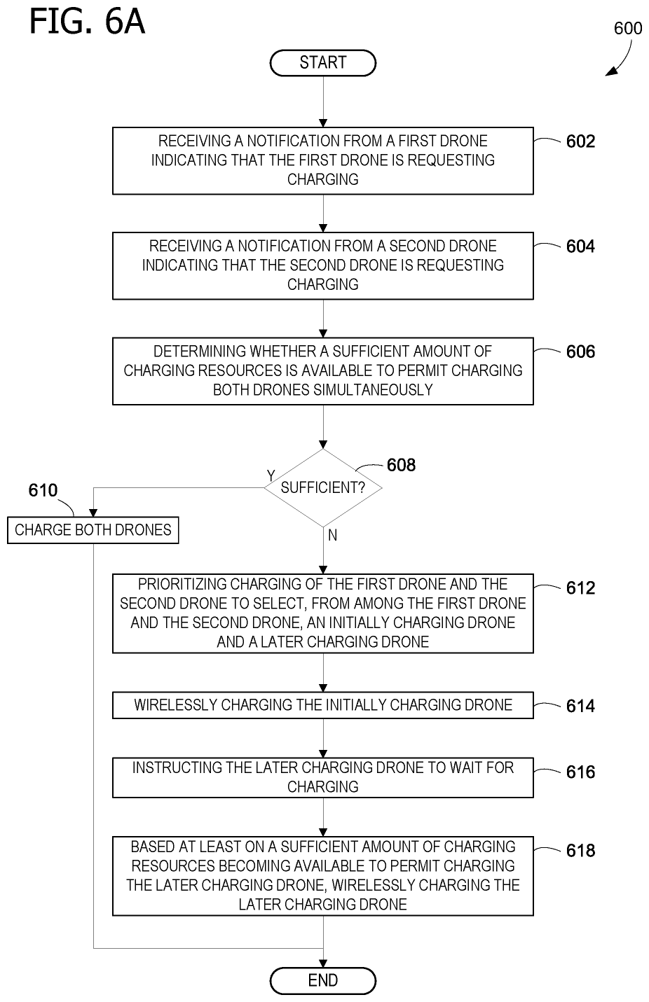

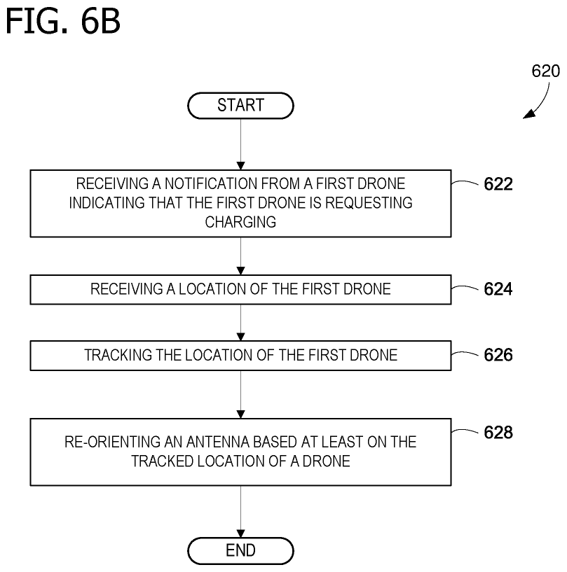

FIG. 6A shows a flow chart 600 illustrating exemplary operational control of wireless charging. The operations illustrated in flow chart 600 may be performed by a compatible processing unit or computing node, such as the computing device of FIG. 8. Operation 602 includes receiving a notification from a first drone indicating that the first drone is requesting charging. Operation 604 includes receiving a notification from a second drone indicating that the second drone is requesting charging. Operation 606 includes determining whether a sufficient amount of charging resources is available to permit charging both drones simultaneously. If decision operation 608 determines there are sufficient resources available, operation 610 charges both drones. Otherwise, operation 612 includes responsive to determining that a sufficient amount of charging resources is not available to permit charging both drones simultaneously, prioritizing charging of the first drone and the second drone to select, from among the first drone and the second drone, an initially-charging drone and a later-charging drone. Operation 614 includes wirelessly charging the initially-charging drone, and operation 616 includes instructing the later-charging drone to wait for charging. Operation 618 includes based at least on a sufficient amount of charging resources becoming available to permit charging the later-charging drone, wirelessly charging the later-charging drone.

FIG. 6B shows a flow chart 620 illustrating exemplary operational control of wireless charging. The operations illustrated in flow chart 620 may be performed by a compatible processing unit or computing node, such as the computing device of FIG. 8. Operation 622 includes receiving a notification from a first drone indicating that the first drone is requesting charging. Operation 624 includes receiving a location of the first drone. Operation 626 includes tracking the location of the first drone. Operation 628 includes re-orienting an antenna based at least on the tracked location of a drone.

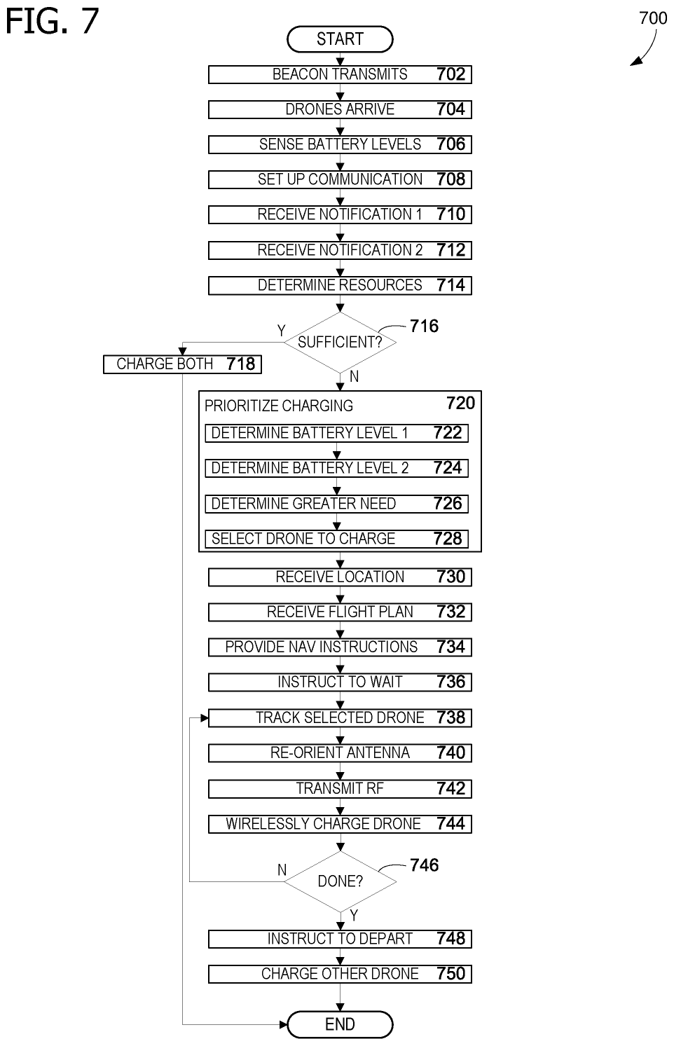

FIG. 7 shows a flow chart 700 illustrating exemplary operations involved in control of wireless charging. The operations illustrated in flow chart 700 may be performed by a compatible processing unit or computing node, such as the computing device of FIG. 8. In operation 702, a beacon transmits the availability of wireless charging, and drones arrive 704. In an exemplary operation, the drones may include a first drone and a second drone. At least one of the first drone and the second drone may comprise a UAV; at least one of the first drone and the second drone may comprise a UGV, and at least one of the first drone and the second drone may comprise an autonomous drone. In operation 706, each drone senses its battery level, and the drones set up communications 708 with an orchestrator. The drones may, for example transmit an ID number, so that the orchestrator can distinguish among them.

In operation 710, the orchestrator receives a notification from the first drone indicating that the first drone is requesting charging. In operation 712, the orchestrator receives a notification from the second drone indicating that the second drone is requesting charging. The orchestrator determines whether a sufficient amount of charging resources is available to permit charging both drones simultaneously, in operation 714. If, in decision operation 716, it is determined that sufficient resources are available, both drones are charged 718. Otherwise, responsive to determining that a sufficient amount of charging resources is not available to permit charging both drones simultaneously, operation 720 prioritizes charging of the first drone and the second drone to select, from among the first drone and the second drone, an initially-charging drone and a later-charging drone.

Operation 720 includes the indicated operations: Operation 722 includes determining a battery level of the first drone. Operation 724 includes determining a battery level of the second drone. In operation 726, based at least on the battery level of the first drone and the battery level of the second drone, the orchestrator determines which of the first drone and the second drone is in greater need of charging. Operation 728 selects a drone to charge first (the initially-charging drone). In operation 730, the orchestrator receives the location of the selected drone (the initially-charging drone) and receives the flight plan of the drone selected for charging in operation 732.

In operation 734, the orchestrator provides navigation instructions to the initially-charging drone, perhaps by providing navigation instructions to a charging corral, or a traffic lane used for charging, or telling it to hover (if it is a UAV). The orchestrator may also provide navigation instructions to the later-charging drone to direct it to a waiting area and instruct the later-charging drone to wait for charging, in operation 736. As part of the instructions in operations 734 and 736, the orchestrator may provide information to UAVs about no-fly zones or preferred flight heights.

Operation 738 includes tracking a location of a drone, in this case, tracking the initially-charging drone. Operation 740 will re-orient an antenna, if a re-orientable antenna is used. The antenna may be re-oriented based at least on the tracked location of the drone being charged, to keep the antenna pointing at the drone. In operation 742, the orchestrator controls at least one antenna to transmit RF charging power but may direct more than one antenna at the drone being charged. This then wirelessly charges the initially-charging drone 744. Decision operation 746 determines whether the charging is complete for the drone. This may be because the drone's battery is full, or because the orchestrator determines that another drone has a greater, more urgent need. In operation, 748, the initially-charging drone is instructed to depart. Operation 750 includes based at least on a sufficient amount of charging resources becoming available to permit charging the later-charging drone, wirelessly charging the later-charging drone.

In some examples, the operations illustrated in the flowcharts may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements. While the aspects of the disclosure have been described in terms of various examples with their associated operations, a person skilled in the art would appreciate that a combination of operations from any number of different examples or some reordering is also within scope of the aspects of the disclosure.

### Exemplary Operating Environment

FIG. 8 is a block diagram of an example computing device 800 for implementing aspects disclosed herein and is designated generally as computing device 800. Computing device 800 is one example of a suitable computing environment and is not intended to suggest any limitation as to the scope of use or functionality of the invention. Neither should the computing device 800 be interpreted as having any dependency or requirement relating to any one or combination of components/modules illustrated.

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments, where tasks are performed by remote-processing devices that are linked through a communications network.

Computing device 800 includes a bus 810 that directly or indirectly couples the following devices: memory 812, one or more processors 814, one or more presentation components 816, input/output (I/O) ports 818, I/O components 820, a power supply 822, and a network component 824. Computing device 800 should not be interpreted as having any dependency or requirement related to any single component or combination of components illustrated therein. While computing device 800 is depicted as a seemingly single device, multiple computing devices 800 may work together and share the depicted device resources. That is, one or more computer storage devices having computer-executable instructions stored thereon may perform operations disclosed herein. For example, memory 812 may be distributed across multiple devices, processor(s) 814 may provide housed on different devices, and so on.

Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 8 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 8 and the references herein to a “computing device.”

Memory 812 may include any of the computer-readable media discussed herein. Memory 812 may be used to store and access instructions configured to carry out the various operations disclosed herein. In some examples, memory 812 includes computer storage media in the form of volatile and/or nonvolatile memory, removable or non-removable memory, data disks in virtual environments, or a combination thereof.

Processor(s) 814 may include any quantity of processing units that read data from various entities, such as memory 812 or I/O components 820. Specifically, processor(s) 814 are programmed to execute computer-executable instructions for implementing aspects of the disclosure. The instructions may be performed by the processor, by multiple processors within the computing device 800, or by a processor external to the client computing device 800. In some examples, the processor(s) 814 are programmed to execute instructions such as those illustrated in the flowcharts discussed below and depicted in the accompanying drawings. Moreover, in some examples, the processor(s) 814 represent an implementation of analog techniques to perform the operations described herein. For example, the operations may be performed by an analog client computing device 800 and/or a digital client computing device 800.

Presentation component(s) 816 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways.

Ports 818 allow computing device 800 to be logically coupled to other devices including I/O components 820, some of which may be built in. Examples I/O components 820 include, for example but without limitation, a microphone, keyboard, mouse, joystick, game pad, satellite dish, scanner, printer, wireless device, etc.

In some examples, the network component 824 includes a network interface card and/or computer-executable instructions (e.g., a driver) for operating the network interface card. Communication between the computing device 800 and other devices may occur using any protocol or mechanism over any wired or wireless connection. In some examples, the network component 824 is operable to communicate data over public, private, or hybrid (public and private) using a transfer protocol, between devices wirelessly using short range communication technologies (e.g., near-field communication (NFC), BLUETOOTH® branded communications, or the like), or a combination thereof.

Although described in connection with an example computing device 800, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary system for operational control of wireless charging, implemented on at least one processor, comprises: a processor; and a computer-readable medium storing instructions that are operative when executed by the processor to: receive a notification from a first drone indicating that the first drone is requesting charging; receive a notification from a second drone indicating that the second drone is requesting charging; determine whether a sufficient amount of charging resources is available to permit charging both drones simultaneously; responsive to determining that a sufficient amount of charging resources is not available to permit charging both drones simultaneously: prioritize charging of the first drone and the second drone to select, from among the first drone and the second drone, an initially-charging drone and a later-charging drone; wirelessly charge the initially-charging drone; instruct the later-charging drone to wait for charging; and based at least on a sufficient amount of charging resources becoming available to permit charging the later-charging drone, wirelessly charge the later-charging drone.

An exemplary method for operational control of wireless charging, implemented on at least one processor, comprises: receiving a notification from a first drone indicating that the first drone is requesting charging; receiving a notification from a second drone indicating that the second drone is requesting charging; determining whether a sufficient amount of charging resources is available to permit charging both drones simultaneously; responsive to determining that a sufficient amount of charging resources is not available to permit charging both drones simultaneously: prioritizing charging of the first drone and the second drone to select, from among the first drone and the second drone, an initially-charging drone and a later-charging drone; wirelessly charging the initially-charging drone; instructing the later-charging drone to wait for charging; and based at least on a sufficient amount of charging resources becoming available to permit charging the later-charging drone, wirelessly charging the later-charging drone.

One or more exemplary computer storage devices having a first computer-executable instructions stored thereon for operational control of wireless charging, which, on execution by a computer, cause the computer to perform operations which may comprise: receiving a notification from a first drone indicating that the first drone is requesting charging; receiving a notification from a second drone indicating that the second drone is requesting charging; determining whether a sufficient amount of charging resources is available to permit charging both drones simultaneously; responsive to determining that a sufficient amount of charging resources is not available to permit charging both drones simultaneously: prioritizing charging of the first drone and the second drone to select, from among the first drone and the second drone, an initially-charging drone and a later-charging drone; wirelessly charging the initially-charging drone; instructing the later-charging drone to wait for charging; and based at least on a sufficient amount of charging resources becoming available to permit charging the later-charging drone, wirelessly charging the later-charging drone.

Alternatively, or in addition to the other examples described herein, examples include any combination of the following:
at least one of the first drone and the second drone comprises a UAV;
at least one of the first drone and the second drone comprises a UAV;
at least one of the first drone and the second drone comprises an autonomous drone;
prioritizing charging of the first drone and the second drone comprises determining a battery level of the first drone; determining a battery level of the second drone; and based at least on the battery level of the first drone and the battery level of the second drone, determining which of the first drone and the second drone is in greater need of charging;
an antenna for directing RF charging power in a selected direction, wherein wirelessly charging a drone comprises controlling the antenna to transmit RF charging power;
the antenna is a re-orientable antenna;
wherein wirelessly charging a drone further comprises tracking a location of a drone and re-orienting the antenna based at least on the tracked location of a drone;
a charging corral; and
providing navigation instructions to the charging corral.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for operational control of wireless charging, implemented on at least one processor, the system comprising:
a processor; and
a computer-readable medium storing instructions that are operative when executed by the processor to:
receive a notification from a first drone indicating that the first drone is requesting charging;
receive a notification from a second drone indicating that the second drone is requesting charging;
determine whether a sufficient amount of charging resources is available to permit charging both drones simultaneously;
responsive to determining that a sufficient amount of charging resources is not available to permit charging both drones simultaneously:
prioritize charging of the first drone and the second drone to select, from among the first drone and the second drone, an initially-charging drone and a later-charging drone;
wirelessly charge the initially-charging drone;
instruct the later-charging drone to wait for charging; and
based at least on a sufficient amount of charging resources becoming available to permit charging the later-charging drone, wirelessly charge the later-charging drone.

2. The system of claim 1 wherein at least one of the first drone and the second drone comprises an unmanned aerial vehicle (UAV).

3. The system of claim 1 wherein at least one of the first drone and the second drone comprises an unmanned ground vehicle (UGV).

4. The system of claim 1 wherein at least one of the first drone and the second drone comprises an autonomous drone.

5. The system of claim 1 wherein prioritizing charging of the first drone and the second drone comprises:
determining a battery level of the first drone;
determining a battery level of the second drone; and
based at least on the battery level of the first drone and the battery level of the second drone, determining which of the first drone and the second drone is in greater need of charging.

6. The system of claim 1 further comprising:
an antenna for directing radio frequency (RF) charging power in a selected direction, wherein wirelessly charging a drone comprises controlling the antenna to transmit RF charging power.

7. The system of claim 6 wherein the antenna is a re-orientable antenna, and wherein wirelessly charging a drone further comprises:
tracking the location of a drone; and
re-orienting the antenna based at least on the tracked location of a drone.

8. The system of claim 1 further comprising:
a charging corral, and
wherein the instructions that are further operative to:
provide navigation instructions to the charging corral.

9. A method for operational control of wireless charging, implemented on at least one processor, the method comprising:
receiving a notification from a first drone indicating that the first drone is requesting charging;
receiving a notification from a second drone indicating that the second drone is requesting charging;
determining whether a sufficient amount of charging resources is available to permit charging both drones simultaneously;
responsive to determining that a sufficient amount of charging resources is not available to permit charging both drones simultaneously:
prioritizing charging of the first drone and the second drone to select, from among the first drone and the second drone, an initially-charging drone and a later-charging drone;
wirelessly charging the initially-charging drone;
instructing the later-charging drone to wait for charging; and
based at least on a sufficient amount of charging resources becoming available to permit charging the later-charging drone, wirelessly charging the later-charging drone.

10. The method of claim 9 wherein at least one of the first drone and the second drone comprises an unmanned aerial vehicle (UAV).

11. The method of claim 9 wherein at least one of the first drone and the second drone comprises an unmanned ground vehicle (UGV).

12. The method of claim 9 wherein at least one of the first drone and the second drone comprises an autonomous drone.

13. The method of claim 9 wherein prioritizing charging of the first drone and the second drone comprises:
determining a battery level of the first drone;
determining a battery level of the second drone; and
based at least on the battery level of the first drone and the battery level of the second drone, determining which of the first drone and the second drone is in greater need of charging.

14. The method of claim 9 wherein wirelessly charging a drone comprises controlling an antenna to transmit radio frequency (RF) charging power.

15. The method of claim 14 wherein wirelessly charging a drone further comprises:
tracking a location of a drone; and
re-orienting an antenna based at least on the tracked location of a drone.

16. The method of claim 9 further comprising providing navigation instructions to a charging corral.

17. One or more computer storage devices having computer-executable instructions stored thereon for operational control of wireless charging, which, on execution by a computer, cause the computer to perform operations comprising:
receiving a notification from a first drone indicating that the first drone is requesting charging;
receiving a notification from a second drone indicating that the second drone is requesting charging;
determining whether a sufficient amount of charging resources is available to permit charging both drones simultaneously;
responsive to determining that a sufficient amount of charging resources is not available to permit charging both drones simultaneously:
prioritizing charging of the first drone and the second drone to select, from among the first drone and the second drone, an initially-charging drone and a later-charging drone;
wirelessly charging the initially-charging drone;
instructing the later-charging drone to wait for charging; and
based at least on a sufficient amount of charging resources becoming available to permit charging the later-charging drone, wirelessly charging the later-charging drone.

18. The one or more computer storage devices of claim 17 wherein wirelessly charging a drone comprises controlling an antenna to transmit radio frequency (RF) charging power.

19. The one or more computer storage devices of claim 18 wherein wirelessly charging a drone further comprises:
tracking a location of a drone; and
re-orienting an antenna based at least on the tracked location of a drone.

20. The one or more computer storage devices of claim 17 wherein the operations further comprise:
providing navigation instructions to a charging corral.
